(19) United States
(12) Patent Application Publication
(10) Pub. No.: US 2026/0043740 A1
(43) Pub. Date: Feb. 12, 2026

(54) Imaging Using Reflected Illuminated Structures

(71) Applicant: The Regents of the University of California, Oakland, CA (US)

(72) Inventors: Albert Siryaporn, Irvine, CA (US); Jean-Louis Bru, Irvine, CA (US); Quantum Zhuo, Irvine, CA (US)

(21) Appl. No.: 18/998,479

(22) PCT Filed: Jul. 25, 2023
(86) PCT No.: PCT/US23/28594

§ 371 Date: Jan. 25, 2025

Related U.S. Application Data
(60) Provisional application No. 63/394,015, filed on Aug. 1, 2022.

(51) Int. Cl. G01N 21/47

(52) U.S. Cl. CPC G01N 21/4738; G01N 2021/4773; G01N 2021/4783

(57) ABSTRACT

Imagining using reflected illuminated structures (“IRIS”) in accordance with embodiments of the invention are disclosed. In one embodiment, an IRIS device is provided, the IRIS device comprising: a projector; a camera; a processor operatively connected to the projector and the camera; and a memory storing instructions that, when executed by the processor, cause the image capture device to: project, using the projector, a plurality of illuminated structures onto an object having an optically transparent, translucent, or opaque surface; and capture, using the camera, image data comprising a reflection of the plurality of illuminated structures from the optically transparent, translucent, or opaque surface of the object.

### CROSS-REFERENCE TO RELATED APPLICATION

The current application claims priority to U.S. Provisional Ser. No. 63/394,015 filed on Aug. 1, 2022, the disclosure of which is incorporated herein by reference.

### FEDERAL FUNDING SUPPORT

This invention was made with Government support under Grant No. R56AI163196, awarded by the National Institutes of Health and National Institute of Allergy and Infectious Diseases. The Government has certain rights in the invention.

### FIELD OF THE INVENTION

The present invention generally relates to imaging more specifically to imaging using reflected illuminated structures.

### BACKGROUND

Visible light is a form of electromagnetic radiation which may be used for imaging. Typically, as light travels through an object, photons can be absorbed, reflected or scattered depending on the composition of the object. Optical imaging uses light and properties of photons to obtain images.

### SUMMARY OF THE INVENTION

The various embodiments of the present imagining using reflected illuminated structures (“IRIS”) contain several features, no single one of which is solely responsible for their desirable attributes. In particular, IRIS may be used for imaging surfaces of optically transparent, translucent, or opaque materials. Without limiting the scope of the present embodiments, their more prominent features will now be discussed below. After considering this discussion, and particularly after reading the section entitled “Detailed Description,” one will understand how the features of the present embodiments provide the advantages described herein.

In a first aspect, an Imaging using Reflected Illuminated Structures (“IRIS”) device is provided, the IRIS device comprising: a projector, a camera, a processor operatively connected to the projector and the camera; and a memory storing instructions that, when executed by the processor, cause the image capture device to: project, using the projector, a plurality of illuminated structures onto an object having an optically transparent, translucent, or opaque surface; and capture, using the camera, image data comprising a reflection of the plurality of illuminated structures from the optically transparent, translucent, or opaque surface of the object.

In an embodiment of the first aspect, the plurality of illuminated structures comprises a pattern that increases contrast of at least one feature on the optically transparent, translucent, or opaque surface.

In another embodiment of the first aspect, the pattern comprises an alternating black-and-white structure image of squares.

In another embodiment of the first aspect, the pattern comprises an array of at least 30 by 30 squares.

In another embodiment of the first aspect, each square has a length between .5 to 2 times a length associated with the at least one feature.

In another embodiment of the first aspect, the memory stores additional instructions that, when executed by the processor, further cause the image capture device to adjust the plurality of illuminated structures using at least one illuminated structure setting.

In another embodiment of the first aspect, the at least one illuminated structure setting includes structure type, structure size, intensity, and periodicity.

In another embodiment of the first aspect, the structure type includes squares, discs, polygons, and spheres.

In another embodiment of the first aspect, the memory stores additional instructions that, when executed by the processor, further cause the image capture device to determine whether the optically transparent, translucent, or opaque surface has been captured and further adjust the plurality of illuminated structures using the at least one illuminated structure settings when the optically transparent, translucent, or opaque surface has not been captured.

In another embodiment of the first aspect, the projector is an LCD monitor.

In a second aspect, a method for imaging an object with an optically transparent, translucent, or opaque surface is provided, the method comprising: projecting a plurality of illuminated structures onto the object; and capturing image data comprising a reflection of the plurality of illuminated structures from the optically transparent, translucent, or opaque surface of the object.

In an embodiment of the second aspect, the plurality of illuminated structures comprises a pattern that increases contrast of at least one feature on the optically transparent, translucent, or opaque surface.

In another embodiment of the second aspect, the pattern comprises an alternating black-and-white structure image of squares.

In another embodiment of the second aspect, the pattern comprises an array of at least 30 by 30 squares.

In another embodiment of the second aspect, each square has a length between .5 to 2 times a length associated with the at least one feature.

In another embodiment of the second aspect, the method further comprises adjusting the plurality of illuminated structures using at least one illuminated structure setting.

In another embodiment of the second aspect, the at least one illuminated structure setting includes structure type, structure size, intensity, and periodicity.

In another embodiment of the second aspect, the structure type includes squares, discs, polygons, and spheres.

In another embodiment of the second aspect, the method further comprises determining whether the optically transparent, translucent, or opaque surface has been captured and further adjusting the plurality of illuminated structures using the at least one illuminated structure settings when the optically transparent, translucent, or opaque surface has not been captured.

In another embodiment of the second aspect, the plurality of illuminated structures is projected using an LCD monitor and the image data is captured using a digital camera.

### BRIEF DESCRIPTION OF THE DRAWINGS

The various embodiments of the present imagining using reflected illuminated structures now will be discussed in detail with an emphasis on highlighting the advantageous features. These embodiments depict the novel and non-obvious features of IRIS shown in the accompanying drawings, which are for illustrative purposes only. These drawings include the following figures:

FIG. 1 is a diagram illustrating an experiment set-up utilizing IRIS in accordance with an embodiment of the invention.

FIGS. 2A-B are diagrams illustrating an image captured using IRIS in accordance with an embodiment of the invention and an image captured using standard illumination in accordance with the prior art, respectively.

FIG. 3 is a block diagram illustrating an IRIS device in accordance with an embodiment of the invention.

FIG. 4 is a flowchart illustrating a process for IRIS in accordance with an embodiment of the invention.

FIG. 5 is a flowchart illustrating configuring illuminated structures (“IS”) using at least one IS setting in accordance with an embodiment of the invention.

FIG. 6 is a diagram illustrating Pseudomonas aeruginosa (“P. aeruginosa”) rhamnolipids being observed ahead of swarming cells in accordance with an embodiment of the invention.

FIG. 7 is a diagram illustrating an initial stage for showing Staphylococcus aureus (“S. aureus”) repelling P. aeruginosa swarming populations in accordance with an embodiment of the invention.

FIGS. 8A-B are diagrams illustrating that removing S. aureus phenol soluble modulins (“PSM”) production eliminates repulsion in accordance with an embodiment of the invention.

FIG. 9 is a transmission electron microscopy (“TEM”) image of S. aureus PSM in accordance with an embodiment of the invention.

FIG. 10 is a chart illustrating S. aureus clinical isolates repelling P. aeruginosa in accordance with an embodiment of the invention.

FIGS. 11A-B are diagrams illustrating S. aureus clinical isolates repelling P. aeruginosa in accordance with an embodiment of the invention.

FIG. 12 is a diagram illustrating liquid-liquid phase separation in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

One aspect of the present embodiments includes the realization that IRIS may reveal features of surfaces of optically transparent, translucent, or opaque materials (e.g., water). The present embodiments may be utilized in a broad number of applications including, but not limited to, in the physical sciences, life sciences, and/or engineering. In particular, IRIS may be utilized to characterize liquids and engineered materials. As way of example, the present embodiments were utilized to image surfactant production in the bacterium P. aeruginosa, as further described below.

Another aspect of the present embodiments includes the realization that determining the topography and detailed features of a surface may be an important materials characterization procedure. Further, such procedures may be significantly more challenging for materials that are optically transparent, translucent, or opaque. Conventional imaging techniques using uniform light sources can capture only fractions of the surface in any given image. In particular, the surfaces of optically transparent, translucent, or opaque materials, such as but not limited to, water, are difficult to image. IRIS may be utilized to visualize the surfaces of such materials at high resolution using a relatively low-cost approach. IRIS may be especially powerful in determining the boundary of liquid-solid and liquid-liquid interfaces, which are traditionally difficult to capture. The present embodiments were utilized to visualize surfactant production by bacteria and monitor the movement of the layer at liquid-solid and liquid-liquid interfaces, as further described below.

Another aspect of the present embodiments includes the realization that IRIS may be a low-cost method that provides high resolution visualization of surfaces. In many embodiments, IRIS may be relatively simple to implement, may be non-destructive, and typically require no modification of the material (may also be referred to as “object”) being characterized. In various embodiments, the size of the feature that is visualized may be limited only by the size and periodicity of the structured pattern of the illumination, as further described below. In several embodiments, IRIS may be utilized to capture features such as, but not limited to, micron-sized features using visible light. For example, the present embodiments include imaged edges that are approximately 50 microns in size.

Turning now to the drawings, imaging using reflected illuminated structures are further described below. In many embodiments, IRIS may be utilized as an imaging technique that enables the imaging of optically transparent, translucent, or opaque surfaces. In several embodiments, IRIS may include projecting illuminated structures (“IS”) onto a surface of a material such as, but not limited to, a transparent material. In various embodiments, IRIS may also include capturing reflections of the illuminated structures (may also be referred to as “reflected illuminated structures” (“RIS”)) from the surface of the transparent material. In several embodiments, the IS may be configured using various settings (may also be referred to illuminated structure settings (“IS settings”)) such as, but not limited to structure type, size, intensity, and/or periodicity. In some embodiments, the IS settings may be manually or automatically determined to configure and/or adjust the IS.

In a variety of embodiments, the configuration and/or adjustment of the illuminated structures may allow for the discernment of various features of a range of sizes on the surface, including minor variations present on the surface. For example, features may include variations on a surface due to sources that perturb the surface including, but not limited to, deformities, bubbles, and/or particles that contaminate the surface. In some embodiments, features may include changes on the surface such as, but not limited to, edges. As further described below, an example experiment using IRIS to image optically transparent, translucent, or opaque liquid surfactants that are produced by the bacterium P. aeruginosa on a soft agar surface are provided. IRIS may discern features of the surfactant including edge, edge movement velocity, and changes in the surface topography. Experiment set-ups utilizing IRIS in accordance with embodiments of the invention are further described below.

### Experiment Set-Ups Utilizing Iris

IRIS may enable the imaging of surfaces including, but not limited to, optically transparent, translucent, or opaque surfaces. In many embodiments, IRIS may be utilized for imaging of any object that has a surface that may reflect. For example, IRIS may be utilized to image water, as the surface of water may have ripples that reflect even though light goes through water. As described herein, IRIS may include projecting a structured image comprising illuminated structures to illuminate an object and capturing a reflected image (e.g., reflected illuminated structures) from the object's surface using an image acquisition device, such as, but not limited to, a digital camera. In many embodiments, the reflected illuminated structures may include a reflection of the projected illuminated structures from the surface of the object. In some embodiments, the reflected illuminated structures provide high resolution image of the surface (and the object). In some embodiments, IRIS may include post-processing of the captured image data using processes known to one of skill in the art.

In various embodiments, the structured image may include one or more patterns of illuminated structures that increase the contrast of features on the surface of an object. For example, the structured image may be an alternating black-and-white squares. In some embodiments, the structured image may function as an image kernel. The size and periodicity of the squares may be adjusted such that an array (e.g., 30×30 squares) appears across the object. However, other structure images that improve the contrast of features on the reflective surface may be used, including but not limited to, structured images utilizing discs, polygons, and spheres. In several embodiments, the size of features that need to be discerned from the surface may scale with the structured image. For example, smaller features may be discerned with smaller illuminated structures.

In several embodiments, the configuration of illuminated structures may be determined based on the feature, surface, and/or object of interest. For example, when imaging a liquid edge on a surface, the size of the liquid edge may be used to determine the configuration of the illuminated structures. Generally, a liquid edge may be an edge or cliff having a curvature where the amount of curvature (e.g., how much curvature) may determine the effective size of the liquid edge. The smaller the size of the liquid edge, the smaller the size of illuminated structures (e.g., size of each individual box). For example, if the liquid edge is approximately X units, then the size of the box (e.g., in length of a side) may be set to .5 to 2 times X. From there, the characteristics of the illuminated structures may be optimized to enhance the resolution of the captured image.

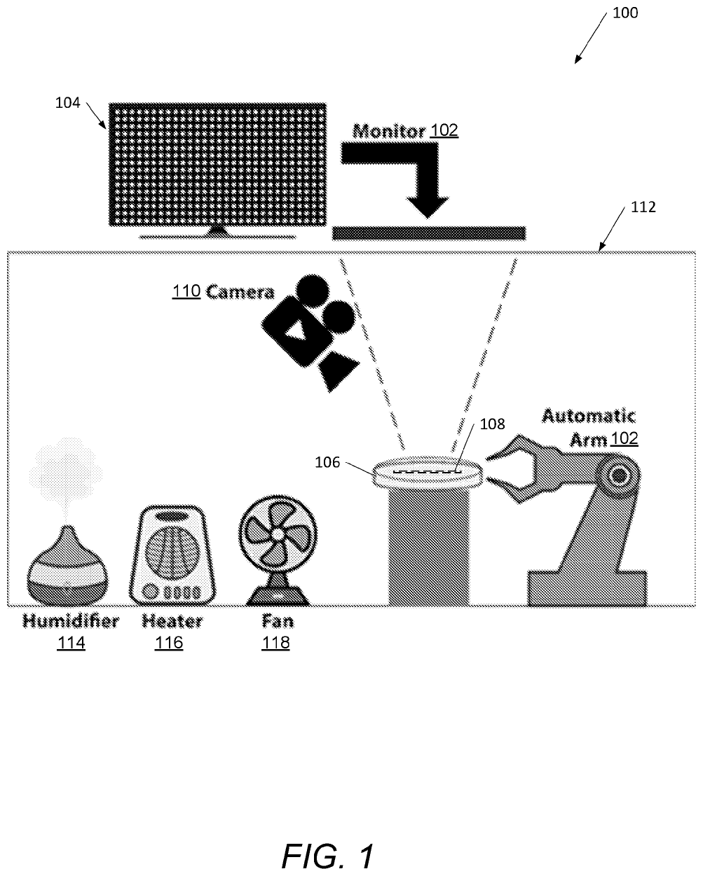

A diagram illustrating an experiment set-up utilizing IRIS in accordance with an embodiment of the invention is shown in FIG. 1. The experiment set-up 100 may include a projector such as, but not limited to, a LCD screen (e.g., a monitor 102) configured to project illuminated structures 104 such as, but not limited to a black and white repeating square pattern onto a Petri dish 106 having an object of interest 108 (e.g., P. aeruginosa). In some embodiments, the monitor 102 may be located above the Petri dish 106. One of ordinary skill would appreciate that the placement of the monitor 102 (e.g., angle, distance, etc. relative to the Petri dish 106) and lighting conditions may be optimized. In many embodiments, the experiment set-up 100 may include a camera 110 for capturing the reflected illuminated structures. One of ordinary skill would appreciate that the placement of the camera 110 (e.g., angle, distance, etc. relative to the Petri dish 106) and lighting conditions may be optimized.

Although the experiment set-up 100 using IRIS is illustrated with the camera 110 and the monitor 102 being separate devices, in some embodiments, a device having a camera and a projector as a singular unit may be utilized, as further described below. In various embodiments, the experiment set-up 100 may also include an acrylic chamber box 112 having a humidifier 114, heater 116, fan 118, and an automatic arm 120. In some embodiments, the camera 110 may be place inside of the acrylic chamber 112 and the monitor 102 may be place outside of the acrylic chamber 112. In some embodiments, the camera 110 and/or the monitor 102 may be either inside or outside of the acrylic chamber 112.

In reference to FIG. 1, to image surfactant production from the object of interest 108 (e.g., P. aeruginosa), the present embodiments utilize IRIS to project illuminated structures 104 from the monitor 102 at the top where the projected illuminated structures 104 were reflected by the P. aeruginosa 108 within in the Petri dish 106. A digital standard reflex lens camera 110 may capture an image of the illuminated structures that are reflected at regular intervals. For example, images may be captured showing a time-lapse of surface deformation showing that the edge is moving. The chamber 112 may also contain a heater 116 set at various temperatures (e.g., 37 degrees ° C.), a humidifier 114 set at various humidity levels (e.g., 50% humidity), an automatic mechanical arm 120 to open and close a lid of the Petri dish 106, and a fan 118 to circulate the air.

Although specific experiment set-ups utilizing IRIS are discussed above with respect to FIG. 1, any of a variety of experiment set-ups using IRIS as appropriate to the requirements of a specific application can be utilized in accordance with embodiments of the invention. Results utilizing IRIS in accordance with embodiments of the invention are further described below.

### Results Utilizing Iris

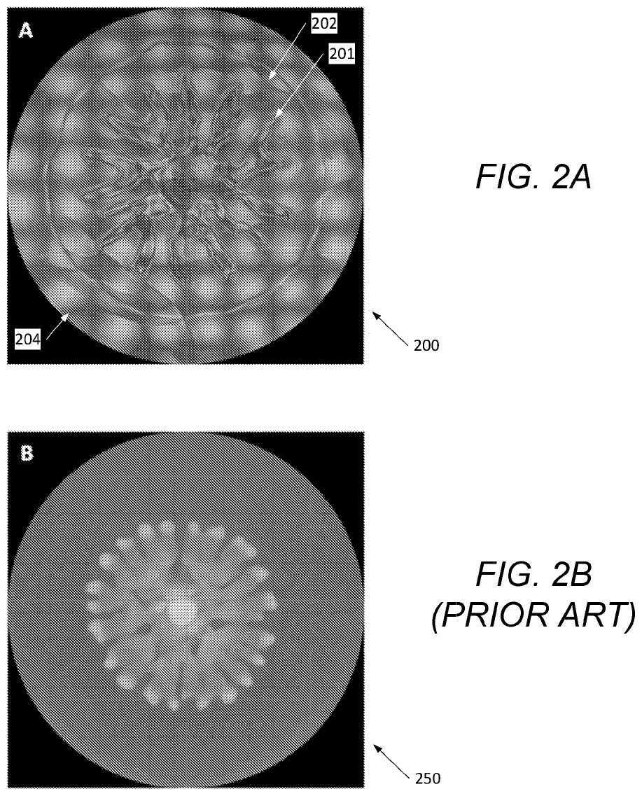

IRIS may be a superior imaging technique to standard illumination processes. Diagrams illustrating an image captured using IRIS in accordance with an embodiment of the invention and an image captured using standard illumination in accordance with the prior art is shown in FIGS. 2A-B, respectively. FIGS. 2A-B show a comparison of swarming P. aeruginosa images 200, 250 using IRIS and standard illumination. Specifically, FIGS. 2A-B illustrate swarm agar assay after 8 hours of growth at 37° C. Wild-type P. aeruginosa strain PA14 was spotted at the center. In reference to FIG. 2A, the image 200 using the IRIS technique reveals changes in the topography of P. aeruginosa tendril surface 201, the layer of rhamnolipids 202 produced by P. aeruginosa, and anisotropies that present on the agar surface 204. The tendril surface 201 is translucent. The rhamnolipids 202 are transparent, and the agar surface 204 is opaque. In contrast, in FIG. 2B, the image of a similar plate using a standard illumination technique.

In reference to FIGS. 2A-B, swarming Petri dishes (100 mm by 15 mm) contained 20 mL of M8 minimal medium supplemented with 1 mM MgSO4, 0.2% glucose, 0.5% casamino acids, and 0.5% agar. Petri dishes were dried in a single stack for 1 hour on the bench and for an additional 30 to 60 minutes at room temperature with the Petri dish lids off in a laminar flow hood at 300 cubic ft/min with approximately 40 to 50% ambient humidity. P. aeruginosa was cultured overnight (16 to 18 h) from single colonies to saturation in LB in a roller drum at 225 rpm at 37° C. Five microliters of culture was spotted in the center of the plates. The plates were then incubated overnight at 37° C. in the chamber. Images were acquired at 30-min intervals for 16 to 18 h with a digital camera. Time-lapse imaging reveals the production of surfactant (i.e., the layer 202 of rhamnolipids) that is produced by the bacteria in FIG. 2A, that is not visible by conventional imaging techniques as illustrated in FIG. 2B.

Although specific results utilizing IRIS are discussed above with respect to FIGS. 2A-B, any of a variety of results from utilizing IRIS as appropriate to the requirements of a specific application can be utilized and/or observed in accordance with embodiments of the invention. Discussion of IRIS in accordance with embodiments of the invention are discussed further below.

### Discussion of Iris

Traditionally, P. aeruginosa has been observed on petri dishes using scanners or digital cameras. These techniques do not resolve the layer of surfactant that is produced by P. aeruginosa. The IRIS technique solves these issues by exposing the surfactant layer forming on a soft agar plate and taking images of this layer over an extended period. The image sequence can then be made into a time-lapse video showing the production of surfactant by P. aeruginosa over the course of several hours. The IRIS method is effective at imaging any type of surfactant produced by microorganisms. This includes, but is not limited to, bacterial strains that swarm on soft agar plates.

Prior to IRIS, the surfactant layer could not be imaged in its entirety. It was possible to obtain imagines of small sections of the surfactant layer by holding the Petri dish at specific angles, but this would obtain only a very localized and limited image of the layer. IRIS has been revolutionary in clearly revealing and consistently helping track the surfactant production over several hours. It may thus be an essential technique to use for observing swarming species of bacteria or surfactant produced by microorganisms.

As further described below, the production of surfactant may be essential to swarming motility in P. aeruginosa. Yet, this aspect of swarming is the least understood. Previous studies have recognized that without surfactant production, P. aeruginosa cannot swarm. It is therefore critical that the rhamnolipid layer is observed alongside with P. aeruginosa swarming on a semi-solid surface. By following the surfactant layer, it is possible to understand how surfactants interact with their surroundings which promote swarming populations of P. aeruginosa.

The ability to discern surface features of materials has extensive applications for solid and liquid materials. As demonstrated, the present embodiments can be used to detect features on liquid surfaces that are not visible through standard illumination techniques. The size of the features that can be detected depend on the size of the illuminated structures. For example, appropriate downsizing or upsizing of the illuminated structure through projection may adjust the detection of the feature. Importantly, the technique works on any material that is optically reflective, even if it is transparent. The IRIS technique can be used to measure features using light from the visible spectrum but can be extended to include the UV and infrared spectra. The versatility of the technique enables the high resolution imaging of a broad range of reflective materials. IRIS devices and processes in accordance with embodiments of the invention are described further below.

### Iris Devices and Processes

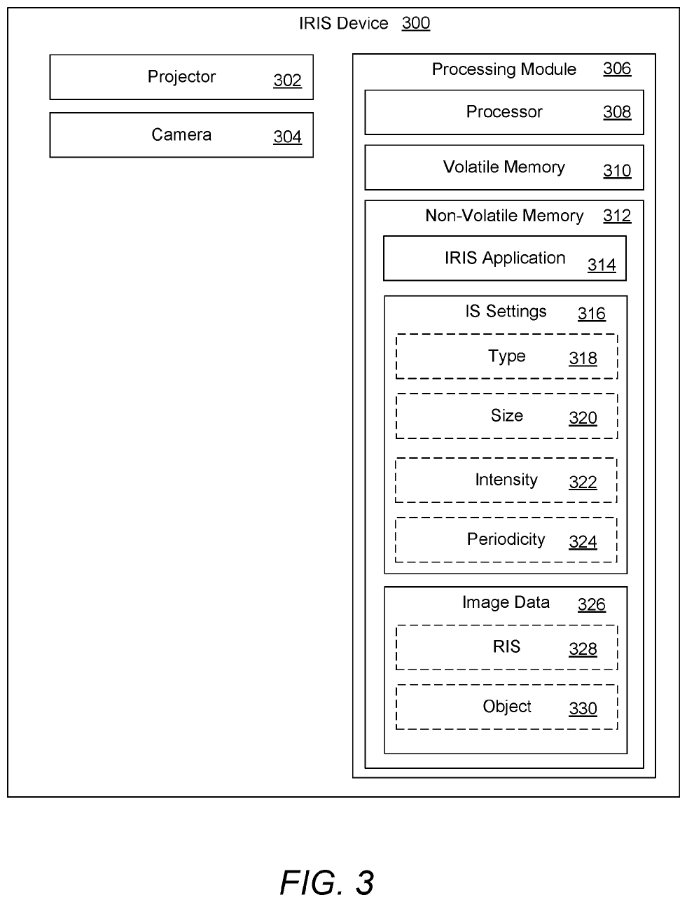

A block diagram illustrating an IRIS device in accordance with an embodiment of the invention is shown in FIG. 3. The IRIS device 300 may comprise a processing module 306 that is operatively connected to a projector 302 and a camera 304. In many embodiments, the projector 302 may be any module capable of projecting illuminated structures. In various embodiments, the camera 304 may be any module capable of capturing reflected illuminated structures. In some embodiments, the projector 302 and the camera 304 may be integrally formed as a single component. In some embodiments, the projector 302 and the camera 304 may be separate devices, as described above.

In reference to FIG. 3, the processing module 306 may comprise a processor 308, volatile memory 310, and non-volatile memory 312 that includes an IRIS application 314. In various embodiments, the IRIS application 314 may configure the processor 308 to project, using the projector 302, IS onto an object having an optically transparent, translucent, or opaque surface and capture image data 326, using the camera 304, that may include the RIS 328 and/or the object 330 that may include the optically transparent, translucent, or opaque surface, as further described below. In some embodiments, the IRIS application 314 may further configure the processor 308 to perform various functions such as, but not limited to, configuring the IS using at least one IS setting 316. In some embodiments, the IS settings 316 may include IS type 318, size 320, intensity 322, periodicity 314, etc. In some embodiments, the IRIS application 314 may further configure the processor 308 to update at least one of IS setting 316, as further described below.

In further reference to FIG. 3, in some embodiments, the IRIS application 314 may configure the processor 308 to display the image data 326 either natively or on another device. In addition, in some embodiments, the IRIS device 300 may include one or more communication modules for communication with other devices such as, but not limited to, a server, display, controller, etc. For example, the IRIS device 300 may utilize various communication protocols such as, but not limited to, Bluetooth, cellular, WiFi, WLAN, etc.

In the illustrated embodiment of FIG. 3, the various components including, but not limited to, the processing module 306, the projector 302, the camera 304 are represented by separate boxes. The graphical representations depicted in FIG. 3 are, however, merely examples, and are not intended to indicate that any of the various components of the IRIS device 300 are necessarily physically separate from one another, although in some embodiments they might be. In other embodiments, however, the structure and/or functionality of any or all of the components of the IRIS device 300 may be combined. In some embodiments, the projector 302 and the camera 304 may include its own processor, volatile memory, and/or non-volatile memory.

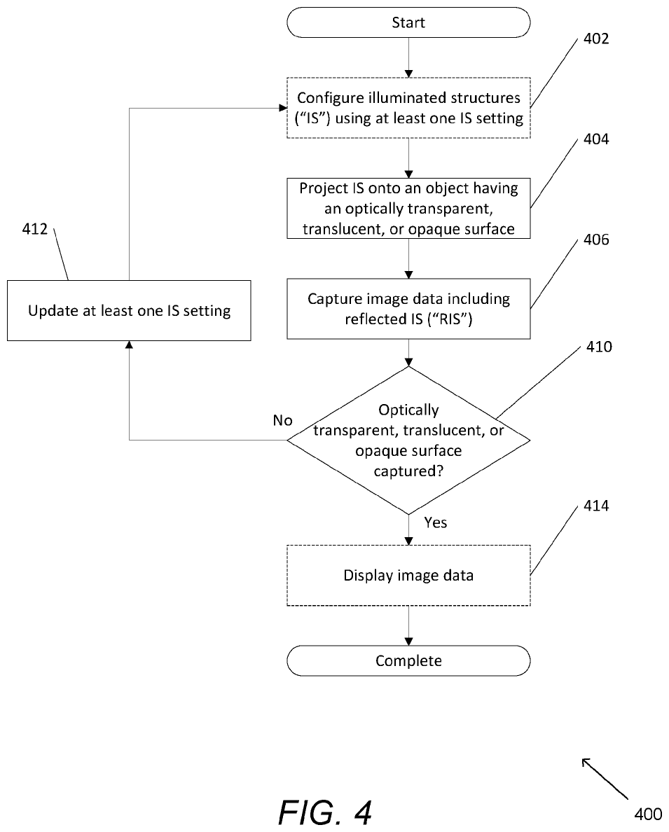

A flowchart illustrating a process for IRIS in accordance with an embodiment of the invention is shown in FIG. 4. The process 400 may include configuring (402) the IS using at least one IS setting, as further described above. The process 400 may also include projecting (404) the IS onto an object having an optically transparent, translucent, or opaque surface, as described herein. As described above, the IS may be a structured image having a pattern (e.g., an alternating black-and-white image of squares). In some embodiments, the pattern may increase contrast of at least one feature on the optically transparent, translucent, or opaque surface. For example, the structured image may be an array having alternating black and white squares. In many embodiments, the IS may be an array such as, but not limited to, 30×30 alternating black and white squares. In various embodiments, the projected IS may appears across the object and reflect from the optically transparent, translucent, or opaque surface thereby producing reflected illuminated structures (“RIS”). The process 400 may also include capturing (406) image data that includes the RIS.

In reference to FIG. 4, the process 400 may also include determining (412) whether the optically transparent, translucent, or opaque surface and/or the object was captured. When it is determined (412) that the object and/or the optically transparent, translucent, or opaque surface was captured, then the process 400 may include displaying (414) the image data. When it is determined (412) that the object and/or the optically transparent, translucent, or opaque surface was not captured, then the process 400 may include updating (412) at least one IS setting and configuring (402) the IS using the updated at least one IS setting.

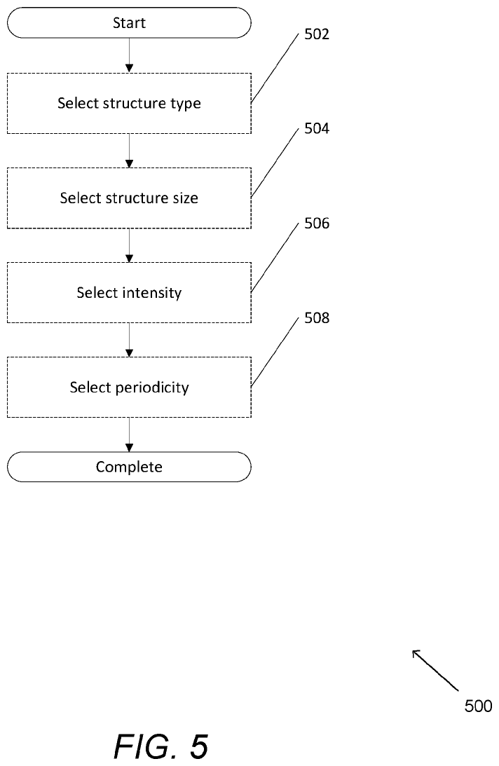

A flowchart illustrating configuring (402) IS using at least one IS setting in accordance with an embodiment of the invention is shown in FIG. 5. The process 500 may include selecting a structure type. In some embodiments, the structure type may be any structure that provides contrast to the features on the reflective surface such as, but not limited to, squares discs, polygons, and spheres. The process 500 may also include selecting (504) a structure size. In some embodiments, the size of the one or more features on the optically transparent, translucent, or opaque surface may determine the selection (504) of the structure size. For example, if the feature of interest is 1 mm, then the structure size may be selected between .5 (i.e., .5 mm) to 2 times (i.e., 2 mm) the feature size. In some embodiments, the structure size may be selected (504) at the lower range and progressive increased until the feature is adequately captured (e.g., the resolution provides visualization of the feature).

In reference to FIG. 5, the process 500 may also include selecting (506) an intensity associated with the IS. For example, the IS may be projected at various intensity to optimize for reflection of the IS on the optically transparent, translucent, or opaque surface. In addition, the process 500 may also include selecting (508) a periodicity of the IS. For example, the IS may be a structured image that may be an array having a periodicity that defines the repetition of the structured type. For example, the IS may be a 30×30 image that is projected onto the object.

Although specific IRIS devices and processes are discussed above with respect to FIGS. 3-5, any of a variety of IRIS devices and processes as appropriate to the requirements of a specific application can be utilized in accordance with embodiments of the invention. Observations of P. aeruginosa swarms in accordance with embodiments of the invention are discussed further below.

### P. Aeruginosa Swarms are Reorganized Phenol Soluble Modulins Produced by S. Aureus

On semi-solid surfaces, P. aeruginosa uses the production of rhamnolipids to decrease surface tension and the rotation of flagella to facilitate swarming movement. This motility is characterized by the formation of tendrils which establishes the bacterial population territory. When P. aeruginosa swarms toward S. aureus, S. aureus can keep P. aeruginosa away by producing phenol-soluble modulin (“PSM”). The present embodiments propose that PSM from S. aureus, which has large hydrophobic side chains relative to few hydrophilic side chains, creates a buffer zone free of cells to repel P. aeruginosa invasion.

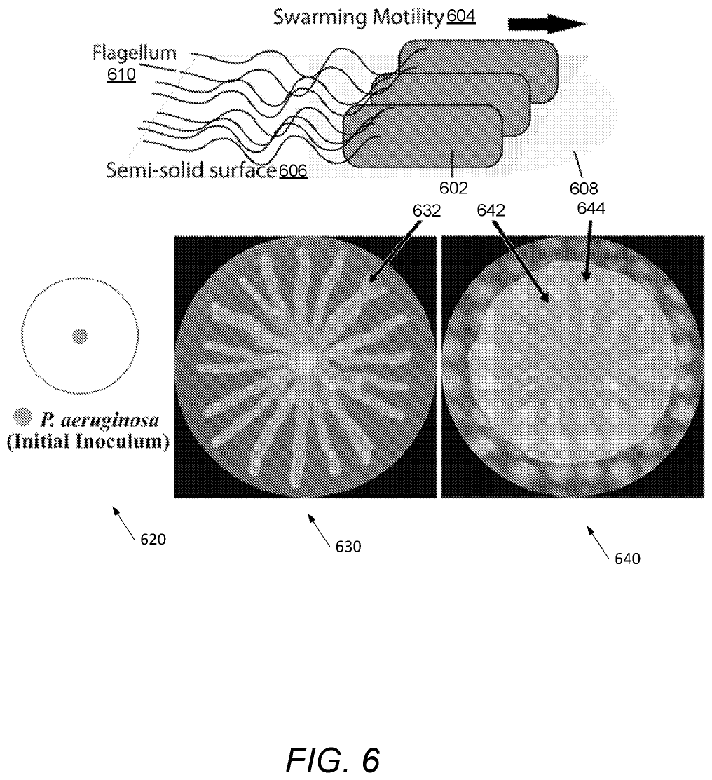

A diagram illustrating P. aeruginosa rhamnolipids being observed ahead of swarming cells in accordance with an embodiment of the invention is shown in FIG. 6. P. aeruginosa 602 swarming motility 604 on semi-solid surface 606 may require rhamnolipids 608 production and the use of flagellum 610. P. aeruginosa populations inflected with bacteriophage or treated with antibiotics through produce of Pseudomonas Quinolone Signaling (“PQS”) molecules may repel P. aeruginosa swarming cells. Here, the present embodiments observe that S. aureus colonies repel P. aeruginosa swarms similar to how P. aeruginosa stressed by bacteriophage or antibiotics repel P. aeruginosa swarms. Although P. aeruginosa and S. aureus co-colonize diverse environments, the defense mechanism from S. aureus may promote the survival of bacterial populations by creating a cell-free zone of repulsion that deviates P. aeruginosa rhamnolipids away from their population. In further reference to FIG. 6, a diagram 620 illustrating an initial inoculum of the P. aeruginosa, a diagram 630 illustrating an image of P. aeruginosa 632 captured using standard illumination, and a diagram 640 illustrating an image of P. aeruginosa 642 and rhamnolipids 644 captured using IRIS are provided.

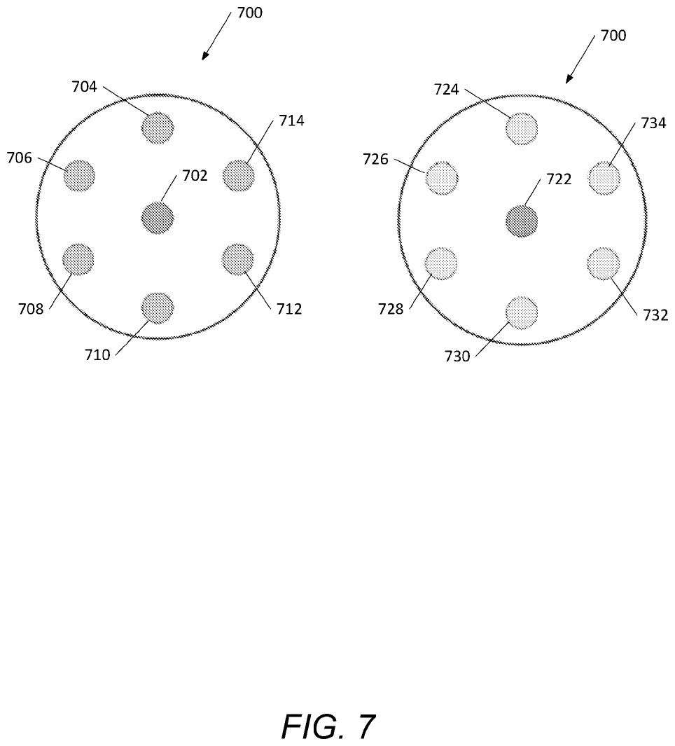

The present embodiments may include determining the S. aureus molecule(s) responsible for P. aeruginosa swarming repulsion. A diagram illustrating an initial stage for showing S. aureus repelling P. aeruginosa swarming populations in accordance with an embodiment of the invention is shown in FIG. 7. In plate 700, a P. aeruginosa 702 bacteria is shown in the middle and six satellite placement of another species of bacteria, the S. aureus 704, 706, 708, 710, 712, 714. In plate 720, a P. aeruginosa 722 bacteria is shown in the middle and six satellite placement of the S. aureus with a PSM mutation 724, 726, 728, 730, 732, 734.

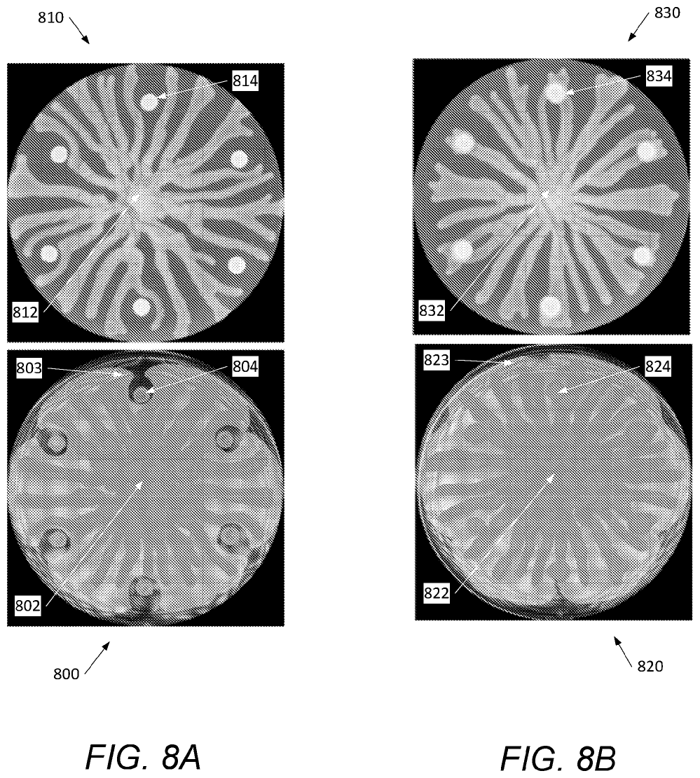

Diagrams illustrating removing S. aureus phenol soluble modulins (“PSM”) production eliminate repulsion in accordance with an embodiment of the invention is shown in FIGS. 8A-B. In reference to FIG. 8A, diagram 800 is captured utilizing IRIS and illustrates P. aeruginosa 802 (rhamnolipids 803 visible with IRIS) with six satellite placement of S. aureus (e.g., S. aureus 804) without the PSM mutation. Diagram 800 illustrates the S. aureus 804 without the PSM mutation repulsing the P. aeruginosa 802 (and the rhamnolipids 803) as there is no overlapping between the S. aureus 804 and the P. aeruginosa 802. Diagram 810 is captured utilizing standard illumination and illustrates P. aeruginosa 812 with six satellite placement of S. aureus (e.g., S. aureus 814) without the PSM mutation. Diagram 810 similarly illustrates the S. aureus 814 without the PSM mutation repulsing the P. aeruginosa 812 as there is no overlapping between the S. aureus 814 and the P. aeruginosa 812.

In reference to FIG. 8B, diagram 820 is captured utilizing IRIS and illustrates P. aeruginosa 822 (which produces rhamnolipids 823) with six satellite placement of S. aureus (e.g., S. aureus 824) with the PSM mutation. Diagram 820 illustrates the S. aureus 804 with the PSM mutation is no longer able to repulse the P. aeruginosa 822 (or rhamnolipids 823) as there is overlapping between the S. aureus 824 (and rhamnolipids 823) and the P. aeruginosa 822. Diagram 830 is captured utilizing standard illumination and illustrates P. aeruginosa 832 with six satellite placement of S. aureus (e.g., S. aureus 834) with the PSM mutation. Diagram 830 similarly illustrates the S. aureus 834 with the PSM mutation not able to repulse the P. aeruginosa 832 as there is overlapping between the S. aureus 834 and the P. aeruginosa 832. FIGS. 8A-B indicate that with the PSM mutation (thus removing S. aureus PSM production) eliminates repulsion.

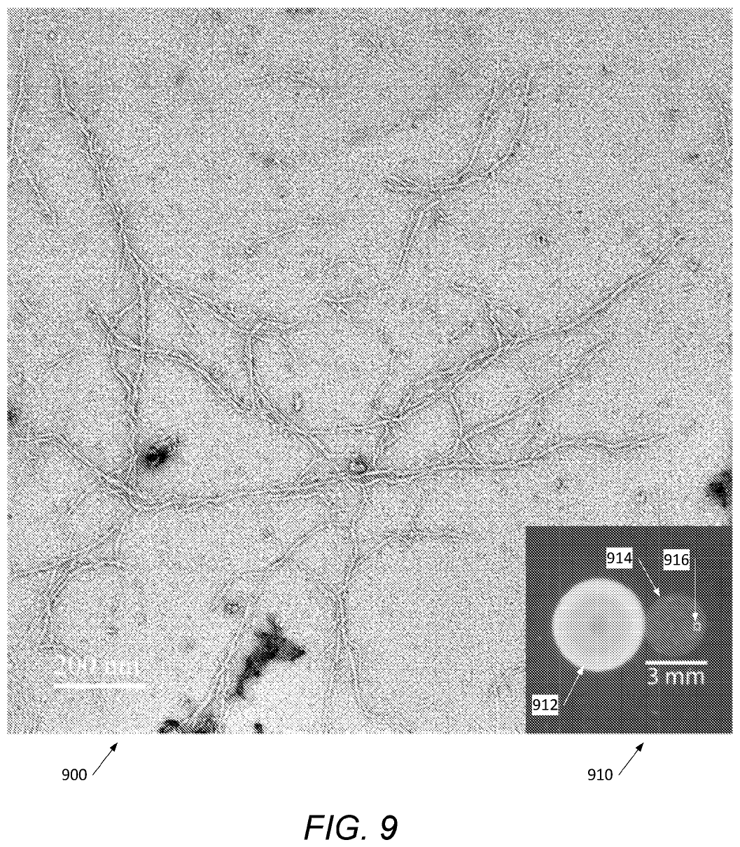

A transmission electron microscopy (“TEM”) image of S. aureus PSM in accordance with an embodiment of the invention is shown in FIG. 9. Diagram 900 is a TEM image of S. aureus PSM produced by S. aureus. The inset 910 shows S. aureus 912 next to a TEM grid 914 with a box 916 that has been enlarged and shown in diagram 900.

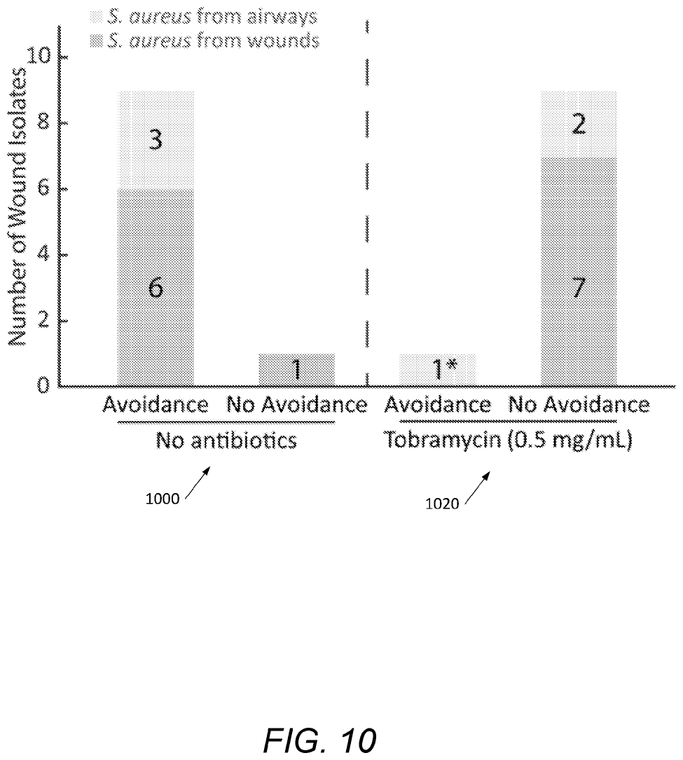

A chart illustrating S. aureus clinical isolates also repelling (may also be referred to as avoidance) P. aeruginosa in accordance with an embodiment of the invention is shown in FIG. 10. The chart illustrates results using no antibiotics 1000 and results using antibiotics (e.g., Tobramycin (0.5 mg/mL)). With no antibiotics, avoidance was observed in 9 wound isolates (i.e., 6 S. aureus from wounds and 3 S. aureus from airways) and no avoidance was observed in 1 wound isolate (i.e., 1 S. aureus from wounds). With antibiotics, avoidance was observed in 1 would isolate (i.e., 1 S. aureus from airways) and 9 no avoidance was observed in 9 would isolates (i.e., 7 S. aureus from wounds and 2 S. aureus from airways). The results indicate that when S. aureus exposures are treated with drugs (e.g., antibiotics), the outcomes show similar characteristics as with S. aureus with PSM mutations as further described above.

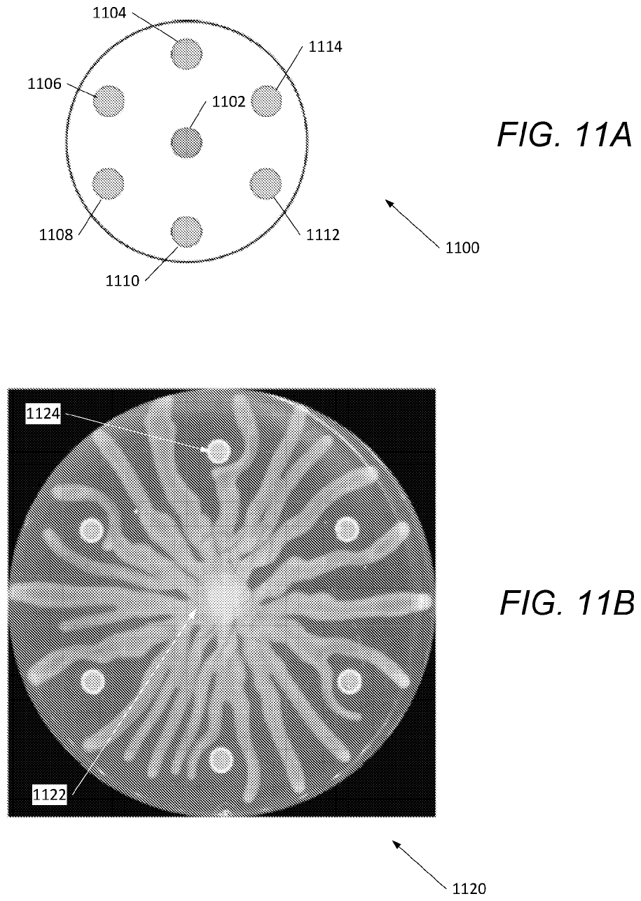

Diagrams illustrating S. aureus clinical isolates repelling P. aeruginosa in accordance with an embodiment of the invention is shown in FIGS. 11A-B. In diagram 1100, a P. aeruginosa 1102 is shown in the middle and six satellite placement of S. aureus (clinical isolates) 1104, 1106, 1108, 1110, 1112, 1114. Diagram 1120 is captured utilizing standard illumination and illustrates P. aeruginosa 1122 with six satellite placement of S. aureus (clinical isolates) (e.g., S. aureus 1124). Diagram 1120 illustrates the S. aureus (clinical isolates) 1124 repulsing the P. aeruginosa 1122 as there is no overlapping between the S. aureus (clinical isolate) 1124 and the P. aeruginosa 1122.

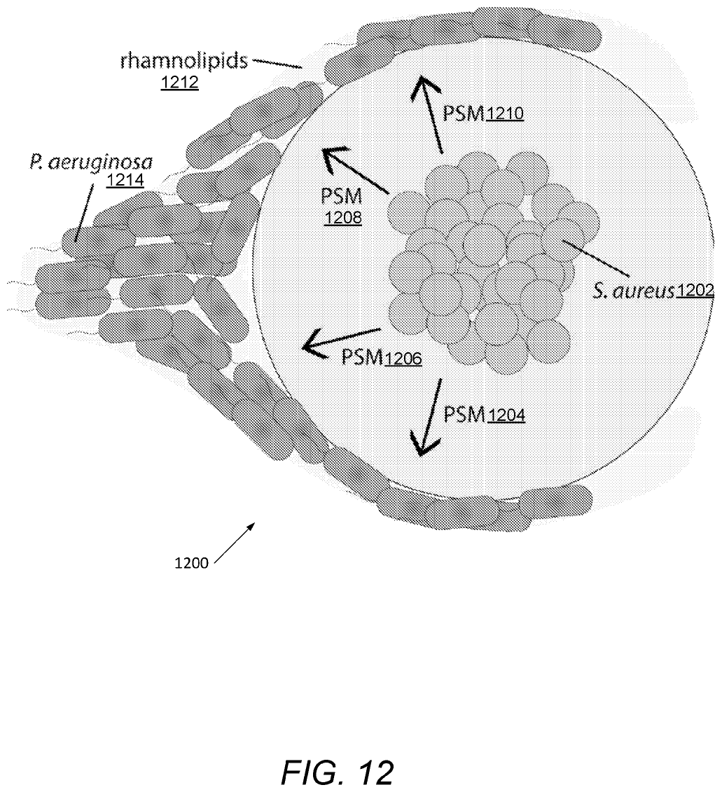

A diagram illustrating liquid-liquid phase separation in accordance with an embodiment of the invention is shown in FIG. 12. On semi-solid surfaces, P. aeruginosa swarms around S. aureus populations. As further described above, the S. aureus Δpsm mutants (no PSM production) do not cause repulsion. PSMs are most likely responsible for disturbing P. aeruginosa swarming patterns. The proposed physical model 1200 (as illustrated in FIG. 12) may explain repulsion. For example, PSMs 1204, 1206, 1208, 1210 produce by S. aureus 1202 do not mix with P. aeruginosa rhamnolipids 1212 of the P. aeruginosa 1214. Further, the liquid-liquid phase between PSMs 1204, 1206, 1208, 1210 and rhamnolipids 1212 may create a cell-free zone of repulsion that prevents physical contact between S. aureus 1202 and P. aeruginosa 1214. The present embodiments may be utilized to determine physical and chemical properties of PSMs and rhamnolipids that allow the species S. aureus and P. aeruginosa to stay separated. Further, the present embodiments may be utilized to understand how rhamnolipids interact with its surrounding to help navigate P. aeruginosa swarming populations.

Although insights and considerations into P. aeruginosa swarms are discussed above with respect to FIGS. 6-12, any of a variety of insights and considerations as appropriate to the requirements of a specific application can be utilized in accordance with embodiments of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. An Imaging using Reflected Illuminated Structures (“IRIS”) device, the IRIS device comprising:
a projector;
a camera;
a processor operatively connected to the projector and the camera; and
a memory storing instructions that, when executed by the processor, cause the image capture device to:
project, using the projector, a plurality of illuminated structures onto an object having an optically transparent, translucent, or opaque surface; and
capture, using the camera, image data comprising a reflection of the plurality of illuminated structures from the optically transparent, translucent, or opaque surface of the object.

2. The IRIS device of claim 1, wherein the plurality of illuminated structures comprises a pattern that increases contrast of at least one feature on the optically transparent, translucent, or opaque surface.

3. The IRIS device of claim 2, wherein the pattern comprises an alternating black-and-white structure image of squares.

4. The IRIS device of claim 3, wherein the pattern comprises an array of at least 30 by 30 squares.

5. The IRIS device of claim 3, wherein each square has a length between .5 to 2 times a length associated with the at least one feature.

6. The IRIS device of claim 3, wherein the memory stores additional instructions that, when executed by the processor, further cause the image capture device to adjust the plurality of illuminated structures using at least one illuminated structure setting.

7. The IRIS device of claim 6, wherein the at least one illuminated structure setting includes structure type, structure size, intensity, and periodicity.

8. The IRIS device of claim 7, wherein the structure type includes squares, discs, polygons, and spheres.

9. The IRIS device of claim 6, wherein the memory stores additional instructions that, when executed by the processor, further cause the image capture device to determine whether the optically transparent, translucent, or opaque surface has been captured and further adjust the plurality of illuminated structures using the at least one illuminated structure settings when the optically transparent, translucent, or opaque surface has not been captured.

10. The IRIS device of claim 1, wherein the projector is an LCD monitor.

11. A method for imaging an object with an optically transparent, translucent, or opaque surface, the method comprising:
projecting a plurality of illuminated structures onto the object; and
capturing image data comprising a reflection of the plurality of illuminated structures from the optically transparent, translucent, or opaque surface of the object.

12. The method of claim 11, wherein the plurality of illuminated structures comprises a pattern that increases contrast of at least one feature on the optically transparent, translucent, or opaque surface.

13. The method of claim 12, wherein the pattern comprises an alternating black-and-white structure image of squares.

14. The method of claim 13, wherein the pattern comprises an array of at least 30 by 30 squares.

15. The method of claim 13, wherein each square has a length between .5 to 2 times a length associated with the at least one feature.

16. The method of claim 11 further comprising adjusting the plurality of illuminated structures using at least one illuminated structure setting.

17. The method of claim 16, wherein the at least one illuminated structure setting includes structure type, structure size, intensity, and periodicity.

18. The method of claim 17, wherein the structure type includes squares, discs, polygons, and spheres.

19. The method of claim 14 further comprising determining whether the optically transparent, translucent, or opaque surface has been captured and further adjusting the plurality of illuminated structures using the at least one illuminated structure settings when the optically transparent, translucent, or opaque surface has not been captured.

20. The method of claim 11, wherein the plurality of illuminated structures is projected using an LCD monitor and the image data is captured using a digital camera.
